(19) United States
(12) Patent Application Publication
(10) Pub. No.: US 2002/0087310 A1
(43) Pub. Date: Jul. 4, 2002

(54) Computer-implemented intelligent dialogue control method and system

(76) Inventors: Victor Wai Leung Lee, Waterloo (CA); Otman A. Basir, Kitchener (CA); Fakhreddine O. Karray, Waterloo (CA); Jiping Sun, Waterloo (CA); Xing Jing, Waterloo (CA)

Correspondence Address: Jones, Day, Reavis and Pogue, North Point, 901 Lakeside Avenue, Cleveland, OH, 44114, US

(21) Appl. No.: 09/863,622

(22) Filed: May 23, 2001

Related U.S. Application Data
(60) Provisional application No. 60/258,911, filed on Dec. 29, 2000.

(51) Int. Cl. G10L 15/04

(52) U.S. Cl. 704/251

(57) ABSTRACT

A computer-implemented method and system for handling a speech dialogue with a user. Speech input from a user contains words directed to a plurality of concepts. The user speech input contains a request for a service to be performed. Speech recognition of the user speech input is used to generate recognized words. A dialogue template is applied to the recognized words. The dialogue template has nodes that are associated with predetermined concepts. The nodes include different request processing information. Conceptual regions are identified within the dialogue template based upon which nodes are associated with concepts that approximately match the concepts of the recognized words. The user's request is processed by using the request processing information of the nodes contained within the identified conceptual regions.

### RELATED APPLICATION

This application claims priority to U.S. Provisional Application Serial No. 60/258,911 entitled “Voice Portal Management System and Method” filed Dec. 29, 2000. By this reference, the full disclosure, including the drawings, of U.S. Provisional Application Serial No. 60/258,911 is incorporated herein.

### FIELD OF THE INVENTION

The present invention relates generally to computer speech processing systems and more particularly, to computer systems that recognize speech.

### BACKGROUND AND SUMMARY OF THE INVENTION

Previous dialogue systems can be menu-driven and system controlled. In such systems a user response is solicited by the system's prompt. In contrast, the present invention allows the user to drive the conversation, rather than following a fixed set of menu steps. The present invention uses a flexible dialogue template. The dialogue template is a set of nodes, in which users can route from one node to any other node, without following a constrained hierarchy.

The flexible routing is provided for in part by the generation and use of dynamic concepts. A dynamic concept generation unit creates a conceptual layer on top of the dialogue template. This conceptual layer is based on already defined semantic words within each node. Nodes are aggregated together to form a concept region or domain. The aggregation is done when an utterance is detected, from which the recognized word is used to drive the aggregation process. This aggregation is dynamic and shifts based upon on-going utterances.

Further areas of applicability of the present invention will become apparent from the detailed description provided hereinafter. It should be understood however that the detailed description and specific examples, while indicating preferred embodiments of the invention, are intended for purposes of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description and the accompanying drawings, wherein:

FIG. 1 is a system block diagram depicting the computer and software-implemented components used by the present invention for dialogue control;

FIG. 2 is a flowchart depicting the steps used by the present invention to process a sentence during a dialogue session;

FIGS. 3 and 4 are structure block diagrams depicting the details of an exemplary node structure of the dialogue template and the process of dynamic conceptual region formation as used by the present invention; and

FIG. 5 is a flow diagram depicting an example of how a user utterance is flexibly processed by the dialogue control unit of the present invention.

### DETAILED DESCRIPTION OF THE PREFERRED EMBODIMENT

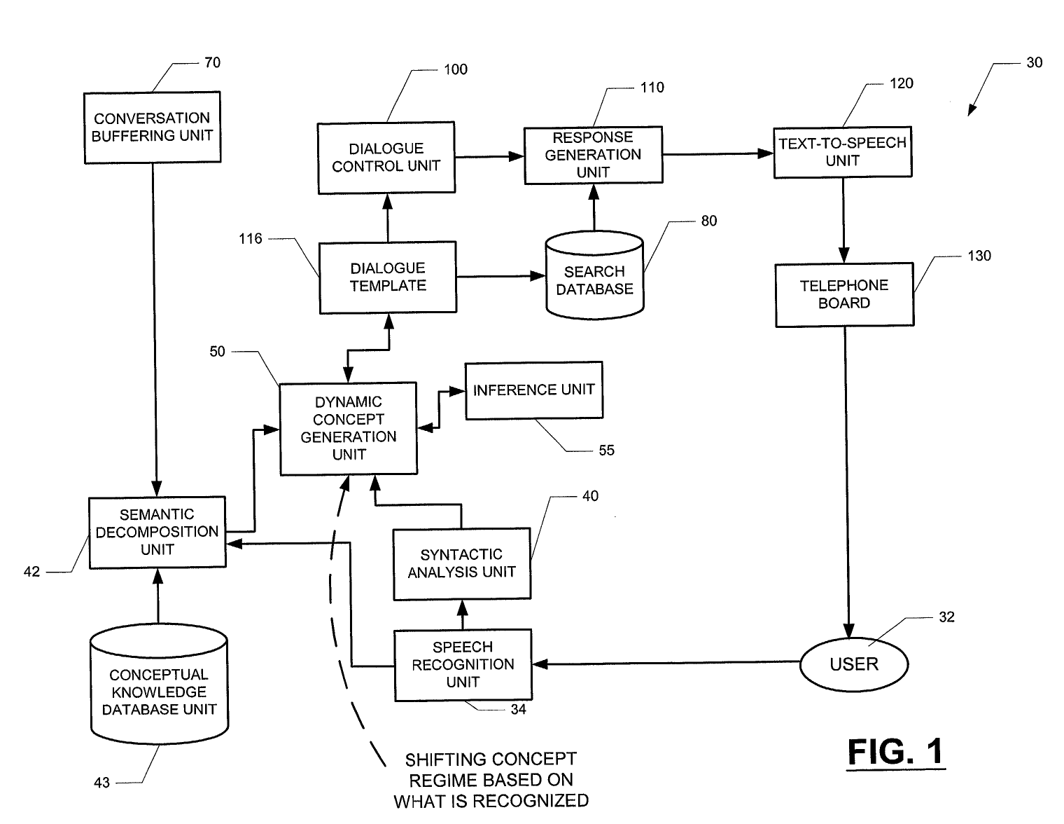

FIG. 1 depicts a speech processing system 30 that allows for a substantially natural conversation with a user 32. A dialogue control unit 100 dynamically regroups the nodes of a dialogue template 116 that fits the conversation with the user 32.

First, a speech recognition unit 34 performs speech recognition of the speech input from the user 32. A syntactic analysis unit 40 and semantic decomposition unit 42 respectively perform syntactic parsing and semantic interpretation. The syntactic analysis unit 40 determines the syntax of the user speech input, such as determining the subject, verb, objects and other grammatical components. The syntactic analysis unit 40 preferably uses grammar models that are described in applicant's United States Patent Application entitled “Computer-Implemented Grammar-Based Speech Understanding Method And System” (identified by applicant's identifier 225133-600-014 and filed on May 23, 2001), which is hereby incorporated by reference (including any and all drawings).

The semantic decomposition unit 42 searches a conceptual knowledge database unit 43 to associate concepts with key words of the user speech input. The conceptual knowledge database unit 43 provides a knowledge base of semantic relationships among words, thus providing a framework for understanding natural language. Each word belongs to predefined sets of concepts. For example, the conceptual knowledge database unit 43 may contain an association (i.e., a mapping) between the word representing the concept “weather” and the word representing the concept “city”. These associations are formed after examining how those words are used on Internet web pages.

More specifically, this association is assigned in the multi-dimensional form of a weighting. The weighting is determined by the relations between the two words as they appear on the websites. Factors affecting the weighting include the frequency of each of the two words appearing on a website, the distance between the words as they appear on the page, and the usage of the words in relation to each other and in relation to the page as a whole. Thus, the conceptual knowledge database unit 43 stores information pertaining to the relation between word pairs as determined by their website usage in the form of weightings. These weightings can then be used by a fuzzy logic engine. Because they indicate word relation and weighting information, weightings are sometimes referred to as vectors.

A conversation buffering unit 70 maintains a record of the current dialogue session. The information in the conversation buffering unit 70 helps the semantic interpretation of the input utterance, to include providing semantic information collected from previous conversations with the user. The conversation buffering unit 70 is described in applicant's United States Patent Application entitled “Computer-Implemented Conversation Buffering Method And System” (identified by applicant's identifier 225133-600-016 and filed on May 23, 2001), which is hereby incorporated by reference (including any and all drawings).

The semantic meaning of the user speech input is relayed to the dynamic conceptual region generation unit 50. The generation unit 50 demarcates the dynamic concept region. To accomplish this, the generation unit 50 creates a dynamic conceptual layer “on top” of the predefined dialogue template structure. This conceptual layer is based on already defined semantic words within each node of the dialogue template 116. Each template node represents a concept that is a portion of an overall concept. Nodes that relate to the specific request of the user are aggregated on-the-fly. The aggregation is done after an utterance is detected and a word is recognized. The recognized word is used to drive the aggregation process. This aggregation is dynamic and shifts based upon on-going user speech input. The aggregation targets the search space as well as creates dynamic language models for further scanning of the user utterance.

Specific nodes exist within the concept region and these nodes have a network linking them together. The network consists of vectors or weighted associations linking a node to another node. Thus, nodes with a higher probability of belonging in a concept region are linked with higher probabilities than nodes that are not as relevant to the concept and are appropriately outside of the concept region.

As an example, the overall task of paying a telephone bill with a credit card contains multiple concepts. The multiple concepts, taken together, form a concept region. Each of the concepts is represented by and corresponds to a node in the dialogue template. One node may be directed to paying a bill, and may be associated with nodes directed to different bill types. One of these associated nodes may be directed to the bill type of telephone bills, and another node may be directed to the concept of payment by a credit card. The relevant template nodes are aggregated together on-the-fly to form a concept region or domain.

The dynamic concept generation unit 50 uses a fuzzy logic inference unit 55 to determine the likelihood that the recognized user input speech is correct. The inference unit 55 is described in applicant's United States patent application entitled “Computer-Implemented Fuzzy Logic Based Data Verification Method And System” (identified by applicant's identifier 225133-600-015 and filed on May 23, 2001), which is hereby incorporated by reference (including any and all drawings).

The fuzzy logic inference unit 55 references other concepts and creates relationships (i.e., associations) among these concepts in the dialogue template. These relationships are not predetermined by the dialog template. Once an association is established, the system can prompt the user with a question. Using the user's answer to the question, the inference unit 55 can jump to other concept regions. That is, additional concepts are added to the dynamically formed concept region. Specifically, additional nodes are added to the network defining the concept region. The concept and the nodes are used to search a database 80 that contains the content information that satisfies the user's request.

The inference unit 55 receives the conceptual network information (containing the vector information) from the conceptual knowledge database unit 43. The inference unit 55 organizes the information into an n^{th} dimensional array and examines the relationships between the words supplied by the speech recognition unit 34. The inference unit 55 dynamically forms networks of concepts.

The dialogue control unit 100 defines a flexible number of system questions that can be asked to the user. The system questions are based on the semantic knowledge obtained by the system from previous questions. These questions are used to further refine the concept domain.

When the user requested information is determined by the system, the dialogue control unit 100 calls the response generation unit 110 to send the response to a text-to-speech unit 120 to synthesize a speech response. This speech response is relayed to the user through the telephone board unit 130.

Through such an approach, the present invention provides flexibility of the dialogue template traversal. This signifies that the predefined dialogue template 116 is not followed strictly from a node to a neighboring node. Control may jump from one node to any other node in the dialogue template network.

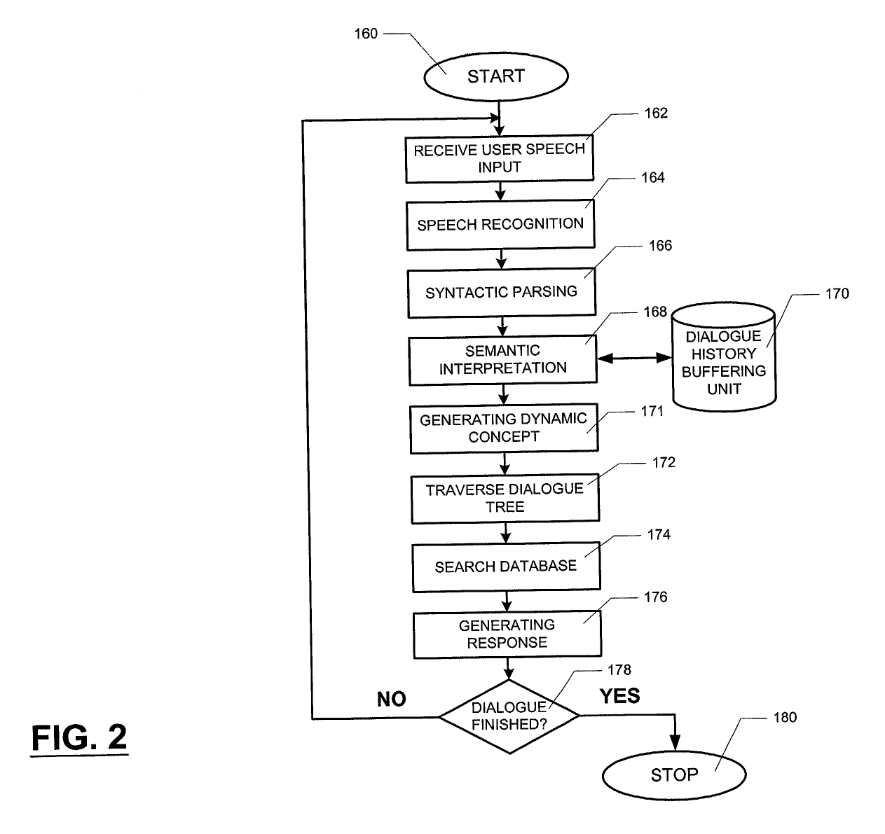

FIG. 2 depicts the steps by which a dialogue is controlled by an embodiment of the present invention. Start block 160 indicates that user speech input (i.e., an utterance that is the user's request) is received at process block 162. The utterance then is relayed to speech recognition process block 164 which transforms sound data into text data and relays the text data to the syntactic parsing process block 166. The syntactic parsing processes block 166 processes the text data and changes it into a syntactic representation. The syntactic representation includes the syntactic structure of the output sequence. That is, it identifies the text term as a noun, verb, adjective, prepositional phrase, or some other grammatical sub unit. For example, if the text data is “Chicago” then it is identified as a proper noun. The text data and the syntactic representation are relayed to the semantic interpretation process block 168.

The semantic interpretation process block 168 consults the dialogue history buffering unit 170 and determines the semantic decomposition of the syntactically represented text data. Using the “Chicago” proper noun example from above, semantic interpretation identifies “Chicago” as a city name.

The semantic interpretation process block 168 relays the text data to process block 171. A dynamic concept region is generated based on the semantic information associated with the text data from the previous block 168. The generated dynamic concept region is overlaid on the dialog template. For example, the dialog template is a general, predefined structure of associated concepts. The associations include the semantic information associated with the text data (e.g., “Chicago”, being identified as a city, is more likely to be grouped with city related concepts than with concepts not related to cities). The inference engine is used to move from static, predefined concept region of the dialog template to a dynamic conceptual region structure. That is, the dialog template may supply a predefined concept region, but the fuzzy logic inference unit creates a shifting concept regime based on what has been recognized via semantic decomposition and syntactic analysis of the utterance.

Process block 171 examines the dynamic conceptual region structure, and process block 172 traverses the dialogue template in order to assemble the relevant concept nodes. The user initiative allows for deviation from the above-mentioned predefined concept structure of the dialog template. In response to user initiative the nodes of the dialog tree are flexibly traversed and aggregated. The flexible traversal forms the dynamic conceptual region, which is then searchable just as the predefined, static dialog template is searchable.

The dynamic conceptual region is thus created and process block 174 issues a search command. With the relevant nodes having been identified, both the dynamic and static conceptual regions can be searched to fulfill the user request. That is, with the dynamic conceptual region defined, the search database is then examined to fulfill the user request.

After the search results fulfilling the user request are obtained, process block 176 generates a response and relays these search results to the user. In this embodiment, the response is a speech response. Decision block 178 then checks if the dialogue has been ended by the user. Depending on the condition checking, the dialogue may continue at process block 162 or finishes at end block 180.

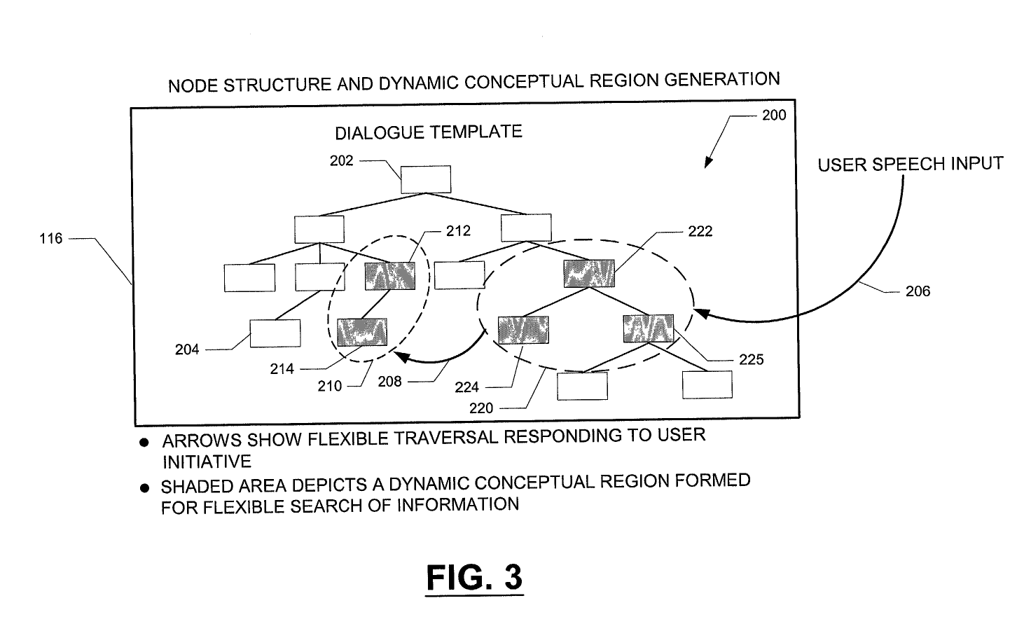

FIG. 3 depicts exemplary dynamic and static structures of the dialogue template 116. The dialogue template 116 has a lattice structure with a tree-like backbone 200. The tree-like backbone 200 describes a top-down view of a dialogue session, beginning at the root node 202 of the tree and ending at one of many leaf nodes, such as leaf node 204. As a static structure, the root node 202 is shown as having two possible sub node choices. Each of those sub nodes has sub nodes of their own. In a typical menu-driven system the backbone 200 is traversed node by node. However in the present invention, a dynamic structure is also created. That is, the backbone can also be traversed with “free” jumps depending on the user's initiative. User initiative means the user can say something freely without following the prompt of the system or the predefined structure of the dialog template 116. The jumps, shown as an example by the arrows 206 and 208, are not predefined, but realized on-the-fly by flexible recombination of the conceptual structures residing on the nodes. The recombination process is realized by the formation of dynamic conceptual regions.

For example, consider that shaded regions of the backbone 200 are concepts relevant to a user speech input. The user speech input may be “I wish to pay my telephone bill and electric bill by credit card”. The concept nodes that relate to this request are identified and dynamically grouped together during run-time to create corresponding concept regions. Concept region 210 may contain nodes directed to the concept of payment methods for a bill. Node 212 within concept region 210 may contain concept information related to payment method, and node 214 within concept region 210 may contain concept information related to the more specific payment method of payment by a credit card. In this example, node 212 contains such information as what are acceptable credit card types (e.g., Visa® and Master Card®) and what response should be provided to the user in the event that the user does not an acceptable credit card type. Node 214 contains such information as ensuring that the user supplies a credit card type, credit card number, and expiration date.

Concept region 220 may contain nodes directed to the concept of bill types. Node 222 within concept region 220 may contain general concept information related to what bill types are able to paid. Node 224 within concept region 220 may contain concept information related to a specific bill type (e.g., telephone bill type) that may be paid. Node 225 within concept region 220 may contain concept information related to a different specific bill type (e.g., electric bill type) that may be paid.

In an embodiment of the present invention, the dynamic conceptual region generation unit identifies which nodes are related to the user's request by identifying the most specific nodes that match the user's recognized speech. To process the user's request, the dynamic conceptual region generation unit flexibly traverses the relevant conceptual regions of the dialogue template 116. First, processing begins at a conceptual region, such as the bill type conceptual region 220 that was dynamically created based upon the user's request (i.e., initiative). The request processing information contained within the nodes 222, 224 and 225 are aggregated to form a dynamic conceptual region, sometimes referred to as a “super node”. The super node indicates how to process the bill type information provided by the user. After concept region 220 finishes processing, the processing jumps as shown by arrow 208 to concept region 210 to acquire information on how to process the credit card payment method.

The conceptual regions may determine that additional information is needed from the user in which case the user is requested to supply the missing information. Before asking the user for the additional information, the present invention can examine previous requests to determine whether information previously supplied by the user may be appropriate and used for the current request. For example, the user may have provided his United States social security number in a previous request during the dialogue session for verification purposes. The present invention can use that information in the current request so that the user does not have to be asked again to provide the information. After the necessary information has been acquired, the database operations specified in the nodes are performed, such as updating the telephone and electrical bill account records of the user.

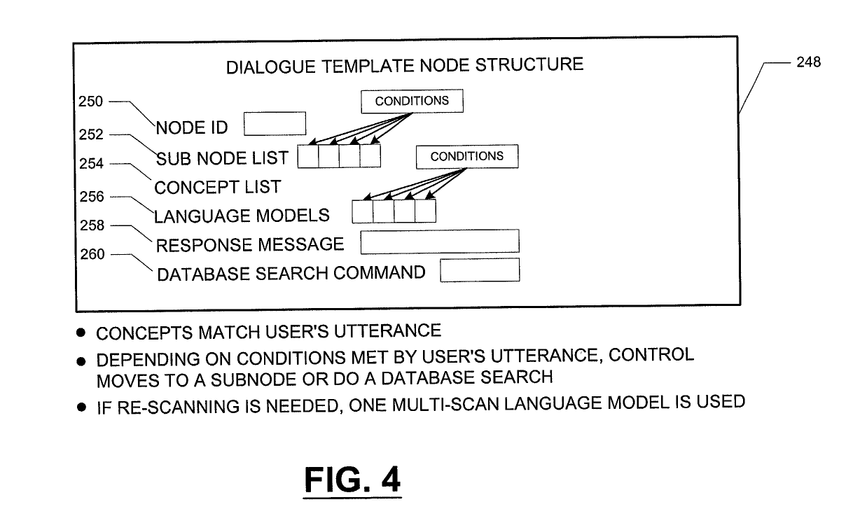

FIG. 4 illustrates the detailed structure of an exemplary single node in the dialogue template and its node request processing information. In particular, a node structure 248 includes a node ID 250 to uniquely identify the node. A sub node list of the tree-like backbone 252 determines which child nodes the present node has and under which conditions traversal to a child node occurs. For example, a node may be directed generally to the concept of what bill types can be paid, and one of its child nodes may contain information specifically related to the telephone bill type. The traversal from the parent to the child node occurs upon the condition being satisfied that the bill type is a telephone bill type.

A concept list 254 is included to match user's input utterance. For example, the bill concept may be associated with similar concepts such as invoice or statement. The concepts in list 254 are used for dynamically creating the flexible jump commands and conceptual regions.

A language model list 256 is included to specify which language recognition models are useful for recognizing unclear words in the user's input utterance. A response message 258 is used to generate a voice response to the user, and a database search command template 260 is used for searching a search database. For example, if a node is directed to payment by a credit card, then a database search is specified to confirm that the user supplied information matches the credit card information in the database.

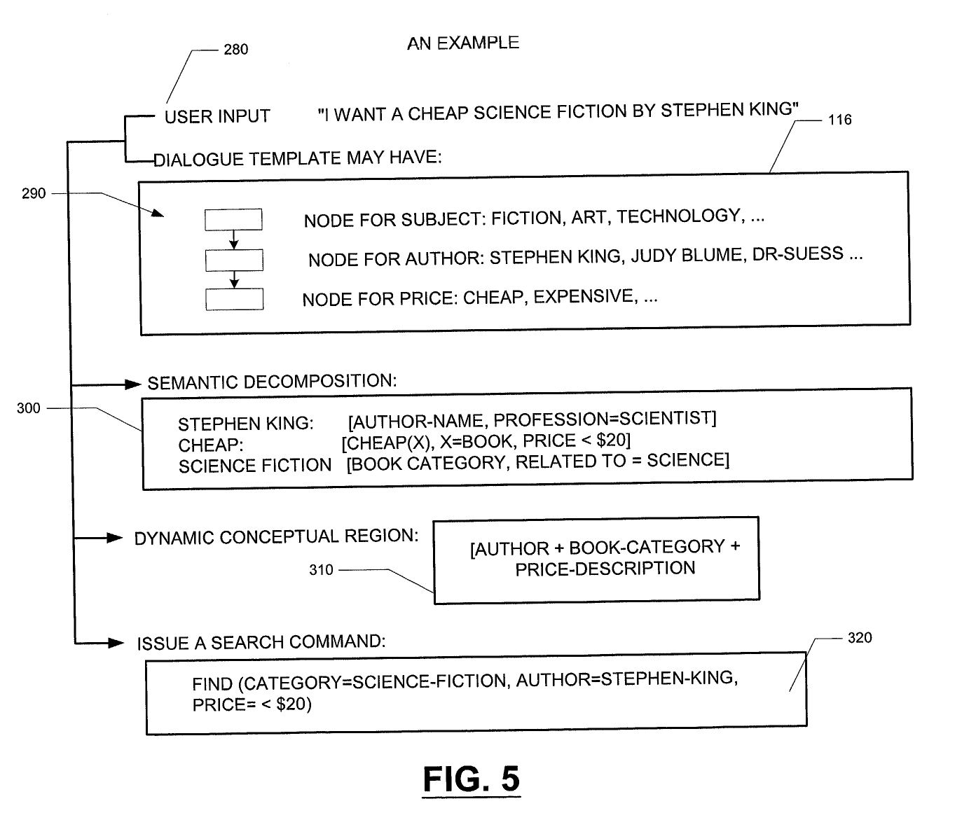

FIG. 5 provides an example showing the dynamic nature of the present invention's dialogue control system. After a user input utterance 280 is recognized it is sent to the dialogue control unit as: “I want a cheap science fiction by Stephen King.” The dialogue control unit has a tree-like structure predefined as a dialogue template. The dialog control unit traverses the dialog template node by node as it gathers information from the user. Because the dialog template is predefined, it cannot foresee all of the possible complex requests a user may present to the system. Therefore, a dynamic concept region generator deals with such a flexibility issue by combining concepts at the nodes so as to reflect the user's needs. Suppose the predefined dialogue template 116 has conceptual nodes for asking the subject of books, the author of books and the price range of a book that are in separate branches. The complex request of the user is handled by the present invention by combining the concepts of the individual nodes as shown by reference number 290. The concepts of the individual nodes can be used effectively when the concepts in the user's utterance are understood and well matched. This is preformed by the semantic decomposition unit.

The results of a semantic decomposition is shown at 300. In the semantic decomposition 300, the word “Stephen King” is understood as a person's name and furthermore as a author. His profession as a scientist increases the probability of being a science writer and a “sci-fi” writer. Such information is useful to the fuzzy-logic inference engine of the inference unit 55 for deciding the appropriateness of the user's request as well as the certainty of the recognition. The adjective “cheap” is treated similarly by giving its classical fuzzy set definition. The word “science fiction” is decomposed into a book-category type and related to science. The information provided by the semantic decomposition 300 is then used by the dynamic conceptual region creation unit which examines the concepts in the respective nodes and matches them by their semantic attributes to the input utterance to generate a conceptual decomposition. The result of the matching leads to the creation of the dynamic conceptual region structure of block 310. The dynamically created conceptual structure 310 has the function of creating and issuing a database search command 320 and generating a system voice response to the user. By this mechanism and function the dialogue control unit realizes the mixed-initiative paradigm that is superior to the current models of dialogue control.

The preferred embodiment described within this document with reference to the drawing figures is presented only to demonstrate an example of the invention. Additional and/or alternative embodiments of the invention will be apparent to one of ordinary skill in the art upon reading the aforementioned disclosure.

It is claimed:

1. A computer-implemented method for handling a speech dialogue with a user, comprising the steps of:
receiving speech input from a user that contains words directed to a plurality of concepts, said user speech input containing a request for a service to be performed;
performing speech recognition of the user speech input to generate recognized words;
applying a dialogue template to the recognized words, said dialogue template having nodes that are associated with predetermined concepts, said nodes including different request processing information;
identifying conceptual regions within the dialogue template based upon which nodes are associated with concepts that approximately match the concepts of the recognized words; and
processing the user's request by using the request processing information of the nodes contained within the identified conceptual regions.
